(19) United States
(12) Patent Application Publication
(10) Pub. No.: US 2015/0067561 A1
(43) Pub. Date: Mar. 5, 2015

(54) ELECTRONIC APPARATUS, METHOD AND STORAGE MEDIUM

(71) Applicant: KABUSHIKI KAISHA TOSHIBA, Tokyo (JP)

(72) Inventor: Yoshihisa Suzuki, Fussa-shi (JP)

(73) Assignee: KABUSHIKI KAISHA TOSHIBA, Tokyo (JP)

(21) Appl. No.: 14/015,718

(22) Filed: Aug. 30, 2013

(51) Int. Cl. G06F 3/0484

(52) U.S. Cl. CPC G06F 3/04845; G06F 3/04842
USPC 715/767

(57) ABSTRACT

An electronic apparatus according to the present embodiment includes a touch input module, a display, a control module, a detection module, and a function assignment module. The control module is configured to make a selected window displayed on the display active. The detection module is configured to detect an application program corresponding to the active window. The function assignment module is configured to assign a function in accordance with the application program detected by the detection module to a touch input module.

### FIELD

Embodiments of the present invention relate to an electronic apparatus, a method, and a storage medium.

### BACKGROUND

Generally, an electronic apparatus including a touch input module as a pointing device is known. Examples of such an electronic apparatus are a notebook personal computer including a touchpad on the top surface of a body housing, a tablet computer including a touchpanel display, a smartphone, etc.

In executing an application program on such an electronic apparatus, depending on the application program, it is sometimes required to perform a fine operation on a touch input module provided for the electronic apparatus.

Here, it is assumed that an application program for reproducing video or music content (hereinafter referred to as a content reproduction application program) on an electronic apparatus is executed. In this case, when a function concerning content reproduction (for example, volume adjustment) is used, a fine operation is often performed on a touch input module (touchpad or touchpanel display).

However, a fine operation on the touch input module as described above is complicated for a user. Further, in reproducing video content, etc., a user sometimes wishes to adjust display brightness. However, since the brightness (adjustment) is managed by an operating system (OS), performing brightness adjustment is also troublesome.

Therefore, a mechanism which enables a function in accordance with an application program executing on an electronic apparatus to be used easily with a touch input module is desired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing an appearance of an electronic apparatus of an embodiment.

FIG. 2 is a diagram showing a system structure of a computer 10.

FIG. 3 is a diagram for schematically explaining a relationship between an OS and a function assignment program of the present embodiment.

FIG. 4 is a flowchart showing procedure of function assignment processing of the present embodiment.

FIG. 5 is an illustration for specifically explaining a function assigned to a touchpad 16.

FIG. 6 is an illustration for specifically explaining a function assigned to the touchpad 16.

FIG. 7 is an illustration for specifically explaining a function assigned to the touchpad 16.

FIG. 8 is a flowchart showing procedure of function cancellation processing of the present embodiment.

### DETAILED DESCRIPTION

Embodiments will be hereinafter described with reference to the accompanying drawings.

An electronic apparatus according to the present embodiment includes a touch input module, a display, a control module, a detection module, and a function assignment module. The control module is configured to make a selected window displayed on the display active. The detection module is configured to detect an application program corresponding to the active window. The function assignment module is configured to assign a function in accordance with an application program detected by the detection module to the touch input module.

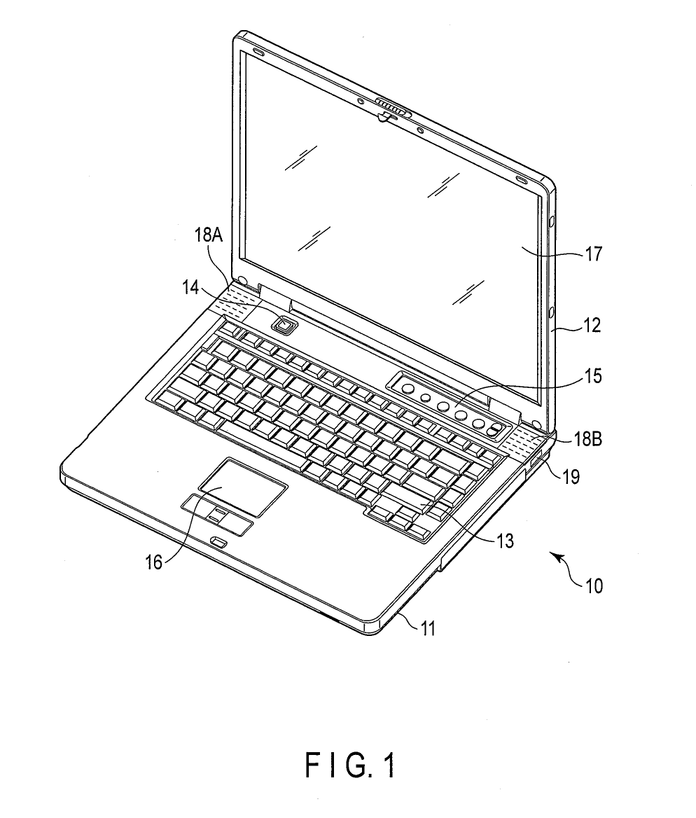

FIG. 1 is a perspective view showing an appearance of an electronic apparatus according to the present embodiment. Here, it is assumed that the electronic apparatus is realized as a notebook personal computer (PC) 10.

As shown in FIG. 1, the computer 10 is comprised of a computer main body 11 and a display unit 12. A liquid crystal display (LCD) 17 is incorporated into the display unit 12. The display unit 12 is attached to the computer main body 11 such that it is rotatably movable between an open position at which the top surface of the computer main body 11 is exposed and a closed position at which the top surface of the computer main body 11 is covered.

The computer main body 11 includes a thin box-like housing. On top of the housing, a keyboard 13, a power button 14 for powering on/off the computer 10, an input operation panel 15, a touchpad 16, speakers 18A and 18B, etc., are arranged. On the input operation panel 15, various operation buttons are provided.

Further, on the right side surface of the computer main body 11, a Universal Serial Bus (USB) connector 19 is provided. Various peripheral devices, such as a USB memory, can be connected to the USB connector 19.

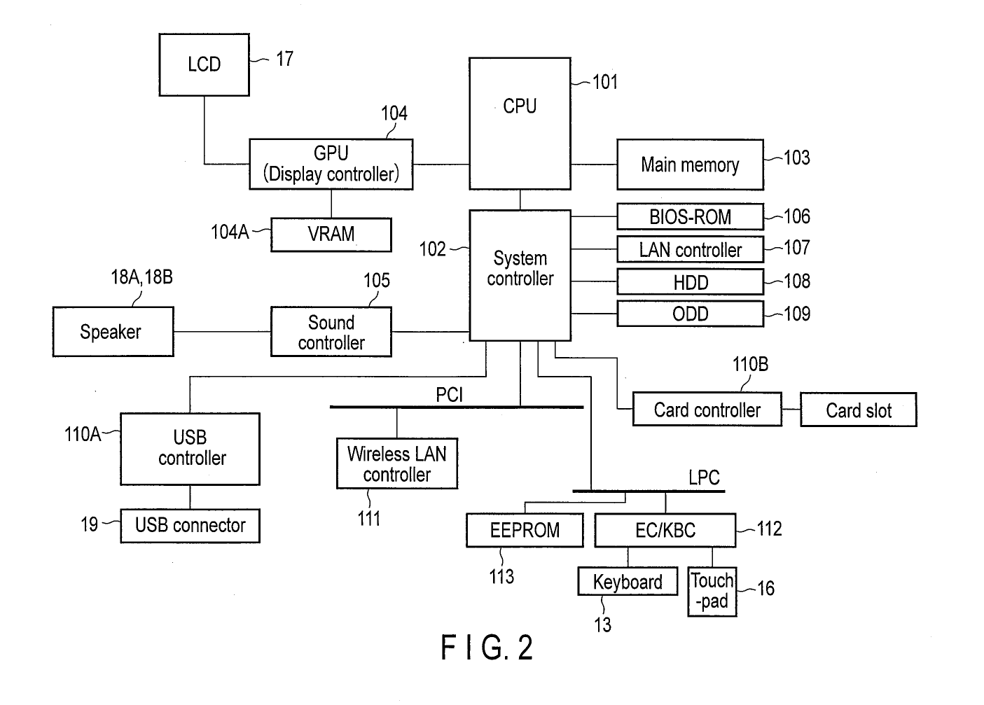

FIG. 2 is a diagram showing a system structure of the computer 10.

As shown in FIG. 2, the computer 10 includes a CPU 101, a system controller 102, a main memory 103, a graphics processing unit (GPU) 104, a video RAM (VRAM) 104A, a sound controller 105, a BIOS-ROM 106, a LAN controller 107, a hard disk drive (HDD) 108, an optical disk drive (ODD) 109, a USB controller 110A, a card controller 110B, a wireless LAN controller 111, an embedded controller/keyboard controller (EC/KBC) 112, an EEPROM 113, etc.

The CPU 101 is a processor for controlling the operation of each component in the computer 10. The CPU 101 executes an operating system (OS), various utility programs, and various application programs which are loaded into the main memory 103 from the HDD 108.

The various utility programs executed by the CPU 101 in the present embodiment includes a utility program for assignment functions (hereinafter referred to as a function assignment program) in accordance with the various application programs launched on the computer 10 to the touchpad (touch input module) 16. Further, the touchpad 16 is generally used as a pointing device which can operate a pointer (mouse pointer) displayed on the display (LCD 17) in accordance with the user's finger sliding (swipe) operation.

The CPU 101 also executes a Basic Input Output System (BIOS) stored in the BIOS-ROM 106. The BIOS is a program for hardware control.

The system controller 102 is a bridge device which connects between the CPU 101 and each component. The system controller 102 incorporates a serial ATA controller for controlling the HDD 108 and the ODD 109. Further, the system controller 102 executes communication with each device on a Low PIN Count (LPC) bus.

The GPU 104 is a display controller for controlling the LCD 17 used as a display monitor of the computer 10. The GPU 104 generates a display signal (LVDS signal) to be supplied to the LCD 17 from display data stored in the video RAM (VRAM) 104A. The display signal generated by the GPU 104 is transmitted to the LCD 17.

The sound controller 105 is a sound source device and outputs audio data to be reproduced to the speakers 18A and 18B.

The LAN controller 107 is a cable communication device which executes cable communication conforming to the IEEE 802.3 standard, for example. On the other hand, the wireless LAN controller 111 is a wireless communication device which executes wireless communication conforming to the IEEE 802.11 standard, for example.

The USB controller 110A executes communication with an external device connected via the USB connector 19.

The card controller 110B executes writing of data in a memory card inserted into a card slot provided on the computer main body 11, and reading of data from the memory card. The EC/KBC 112 is a one-chip microcomputer in which an embedded controller for power management and a keyboard controller for controlling the keyboard 13 and the touchpad 16 are integrated. The EC/KBC 112 has the function of powering on/off the computer 10 in accordance with the operation of the power button 14 by a user.

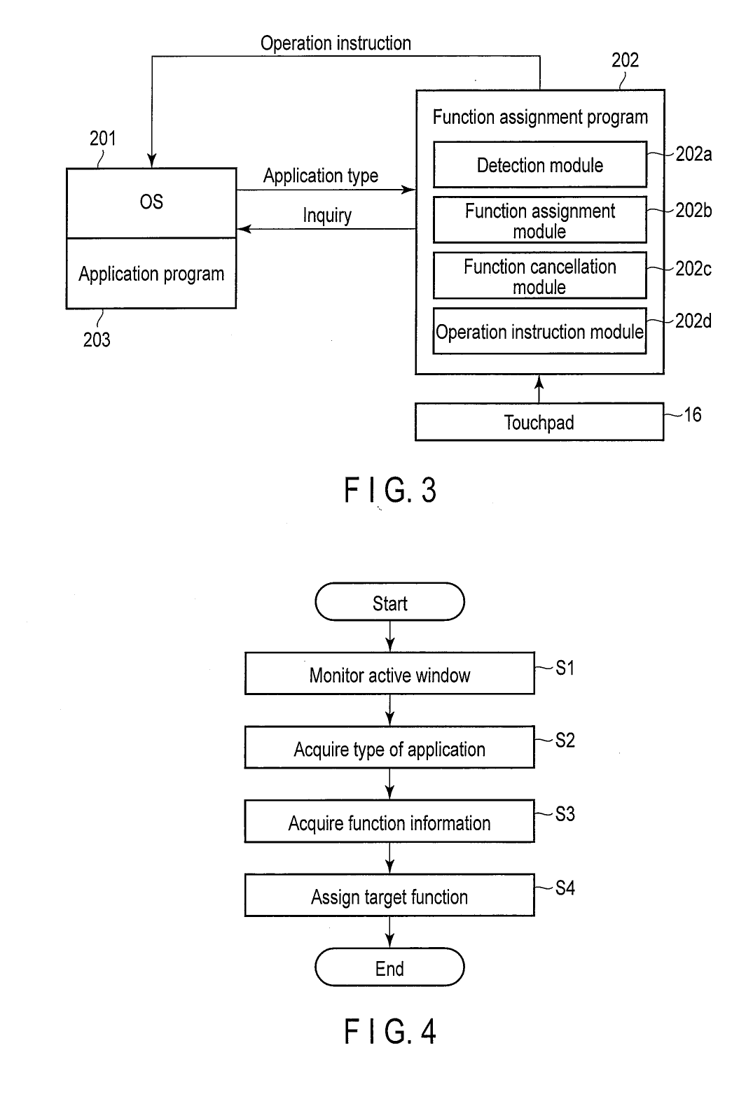

Next, with reference to FIG. 3, a relationship between the OS and the aforementioned function assignment program of the present embodiment will be described schematically.

Here, an OS 201 is software which provides functions used in common by various application programs 203 that run on the computer 10, and manages the whole of computer system.

Further, in a broad sense, the OS 201 includes a window system. The window system assigns specific regions (windows) for application programs 203 launched on the computer 10, respectively. That is, when one of the application programs 203 which needs to be displayed to a user is launched on the computer 10 as described above, a window corresponding to this application program 203 is displayed. Further, the window system executes the control of making the window displayed on the display and selected by the user active.

By such a window system, a user can operate each of the application programs which are simultaneously displayed in their own windows. Further, a window is generally a rectangular region.

A function assignment program 202 is a utility program (software) for causing the CPU 101 (computer) to be operated as a detection module 202a, a function assignment module 202b, a function cancellation module 202c, and an operation instruction module 202d.

The detection module 202a monitors a window in an active state (hereinafter referred to as an “active window”) of the windows displayed on the display. The active window is a window which is a target of input or operation by the user in a multi-window environment that a plurality of windows can be displayed simultaneously.

In this case, the detection module 202a sends an inquiry about the active window to the OS 201, and acquires the type of application program 203 (application type) corresponding to the active window via the OS 201. By doing so, the detection module 202a detects the (type of) application program 203 corresponding to the active window.

The function assignment module 202b holds information (hereinafter referred to as the “function information”) inside the module 202 in advance. The function information shows the function in accordance with the (type of) application program 203 that runs on the computer 10 (namely, the function assigned to the touchpad 16 in accordance with the executed application).

The function assignment module 202b assigns the function in accordance with the application program 203 to the touchpad 16 based on the application program 203 detected by the detection module 202a and the function information.

After the function in accordance with the application program 203 has been assigned to the touchpad 16 as stated above, the function cancellation module 202c cancels the function assigned to the touchpad 16 in accordance with a user's predetermined operation on the touchpad 16. When the function assigned to the touchpad 16 is cancelled, the touchpad 16 is used as a pointing device having the function of operating a pointer displayed on a display monitor.

The operation instruction module 202d provides an instruction based on a user's operation on the touchpad 16 to the OS 201 or various application 203.

To be specific, when a function in accordance with the application program 203 is assigned to the touchpad 16 by the function assignment module 202b as stated above, the operation instruction module 202d converts the substance of operation on the touchpad 16 (namely, a trajectory of a user's finger sliding on the touchpad 16) into instruction information corresponding to the assigned function, and passes the instruction information to the OS 201 or the application program 203.

When the function assigned to the touchpad 16 is cancelled by the function cancellation module 202c (namely, when the touchpad 16 is used as a pointing device which operates a pointer), the operation instruction module 202d passes the substance of operation on the touchpad 16 to the OS 201 or the application program 203.

Next, an operation of the computer 10 according to the present embodiment will be explained. In the computer 10 according to the present embodiment, processing of assigning a function in accordance with the application program 203 launched on the computer 10 (hereinafter referred to as “function assignment processing”) and processing of cancelling a function assigned to the touchpad 16 (hereinafter referred to as “function cancellation processing”) are executed. These types of processing will now be explained.

Firstly, with reference to a flowchart of FIG. 4, the processing procedure of the function assignment processing of the present embodiment will be described. The function assignment processing is executed by the detection module 202a and the function assignment module 202b shown in FIG. 3.

The detection module 202a monitors an active window of the windows displayed on the display (step S1). At this time, the detection module 202a sends an inquiry to the OS 201.

When the application program 203 is launched on the computer 10 and an active window exists, the function assignment module 202a acquires the type of application program 203 corresponding to the active window via the OS 201 (step S2). For convenience, the application program 203 corresponding to the active window is referred to as a target application program 203.

Next, the function assignment module 202b acquires function information indicating the function corresponding to the type of acquired target application program 203 (hereinafter referred to as the “target function”) (step S3). It is assumed that the function information is held inside the function assignment module 202b in advance as stated above.

The function assignment module 202b assigns the target function indicated by the acquired function information to the touchpad 16 (step S4). Further, as will be described later, the target function to be assigned to the touchpad 16 (namely, the function in accordance with the target application program 203) may be more than one.

Once the target function is assigned to the touchpad 16, the fact that the target function has been assigned to the touchpad 16 is stored (set) in a predetermined area of a memory, for example.

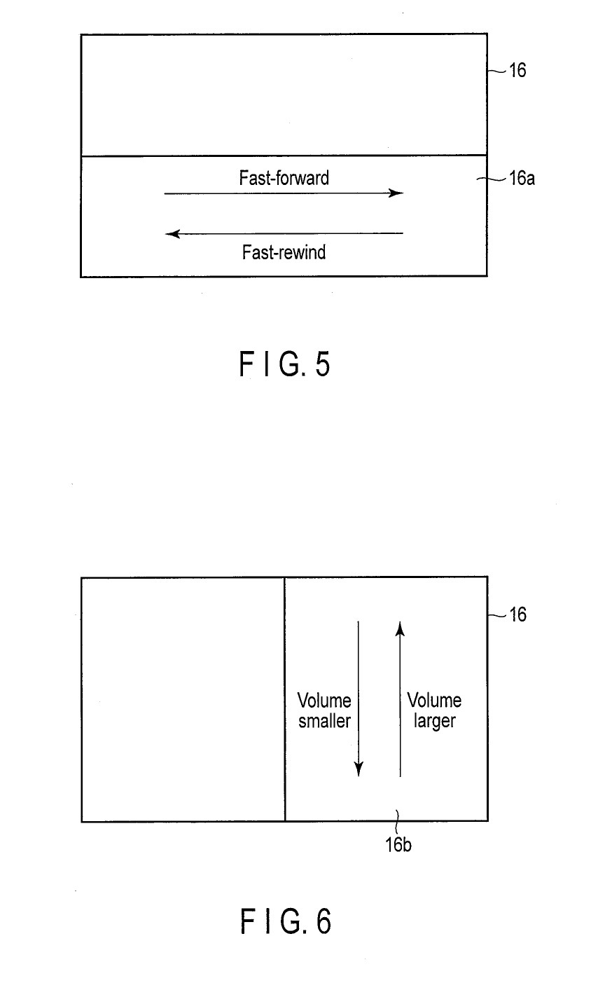

Here, with reference to FIGS. 5 to 7, the function to be assigned to the touchpad 16 will be explained specifically. Here, an explanation will be given assuming that the target application program 203 is an application program 203 for reproducing content including video (or music) (hereinafter referred to as a “content reproduction application program”).

In this case, a function for reproducing the content in the content reproduction application program 203 (hereinafter referred to as a “content reproduction function”), for example, is assigned to the touchpad 16. In the content reproduction function, for example, the function of performing fast-forward reproduction and fast-rewind reproduction of content, volume adjustment during reproduction of the content, and brightness adjustment of a display during reproduction of the content is included.

More specifically, in an area 16a included in the touchpad 16 shown in FIG. 5 (namely, the lower area of the upper and lower divided areas of the touchpad 16), the function of executing fast-forward reproduction of content in the content reproduction application program 203 in accordance with a left-to-right finger sliding operation by a user (operation of brushing the user's finger rightward), for example, is assigned. In the area 16a included in the touchpad 16 to which such a function is assigned, when an operation of sliding the user's finger from left to right is made, instruction information for instructing the fast-forward reproduction of the content is passed from the operation instruction module 202d to the OS 201 or the content reproduction application program 203. In this way, fast-forward reproduction of content in the content reproduction application program 203 is performed.

On the other hand, in the area 16a included in the touchpad 16, the function of executing fast-rewind reproduction of content in the content reproduction application program 203 in accordance with a right-to-left finger sliding operation by a user (operation of brushing the user's finger leftward), for example, is assigned. In the area 16a included in the touchpad 16 to which such a function is assigned, when an operation of sliding the user's finger from right to left is made, instruction information for instructing the fast-rewind reproduction of the content is passed from the operation instruction module 202d to the OS 201 or the content reproduction application program 203. In this way, fast-rewind reproduction of content in the content reproduction application program 203 is performed.

Further, in an area 16b included in the touchpad 16 shown in FIG. 6 (namely, the right area of the right and left divided areas of the touchpad 16), the function of lowering a volume in reproducing the content in the content reproduction application program 203 in accordance with a top-to-bottom finger sliding operation by a user (operation of brushing the user's finger downward), for example, is assigned. In the area 16b included in the touchpad 16 to which such a function is assigned, when an operation of sliding the user's finger from top to bottom is made, instruction information for instructing the lowering of the volume in content reproduction is passed from the operation instruction module 202d to the OS 201 or the content reproduction application program 203. In this way, a volume in reproducing content in the content reproduction application program 203 is lowered.

On the other hand, in the area 16b included in the touchpad 16, the function of increasing a volume in reproducing the content in the content reproduction application program 203 in accordance with a bottom-to-top finger sliding operation by a user (operation of brushing the user's finger upward), for example, is assigned. In the area 16b included in the touchpad 16 to which such a function is assigned, when an operation of sliding the user's finger from bottom to top is made, instruction information for instructing the increasing of the volume in content reproduction is passed from the operation instruction module 202c to the OS 201 or the content reproduction application program 203. In this way, a volume in reproducing content in the content reproduction application program 203 is increased.

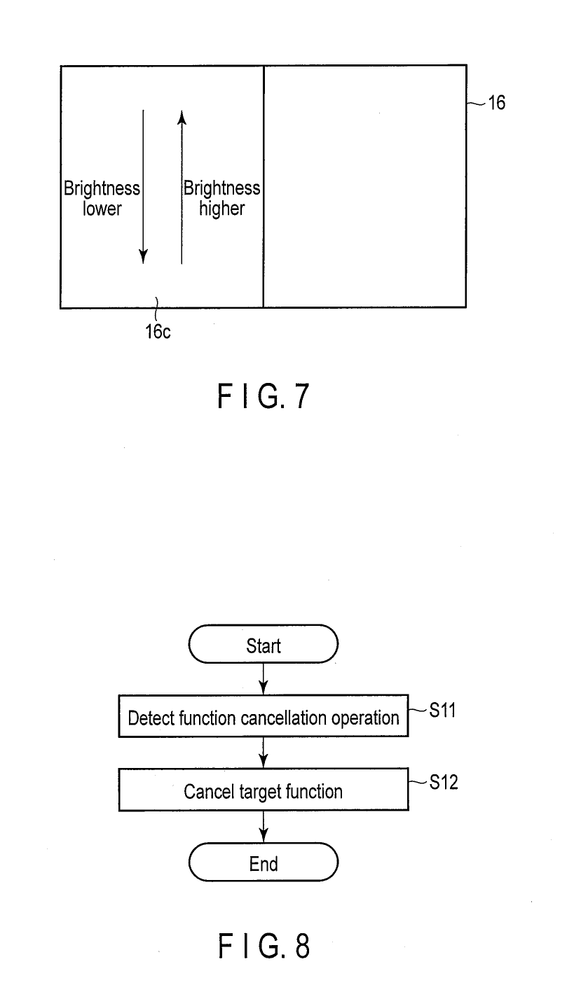

Further, in an area 16c included in the touchpad 16 shown in FIG. 7 (namely, the left area of the right and left divided areas of the touchpad 16), the function of lowering (dimming) brightness of a display monitor (dimming the display monitor) in reproducing the content in the content reproduction application program 203 in accordance with a top-to-bottom finger sliding operation by a user (operation of brushing the user's finger downward), for example, is assigned. In the area 16c included in the touchpad 16 to which such a function is assigned, when an operation of sliding the user's finger from top to bottom is made, instruction information for instructing the lowering of brightness of the display monitor in content reproduction is passed from the operation instruction module 202d to the OS 201 or the content reproduction application program 203. In this way, brightness of the display in reproducing the content in the content reproduction application program 203 is lowered.

On the other hand, in the area 16c included in the touchpad 16, the function of increasing brightness of a display monitor (brightening the display monitor) in reproducing the content in the content reproduction application program 203 in accordance with a bottom-to-top finger sliding operation by a user (operation of brushing the user's finger upward), for example, is assigned. In the area 16c included in the touchpad 16 to which such a function is assigned, when an operation of sliding the user's finger from bottom to top is made, instruction information for instructing the increasing of brightness of the display monitor in content reproduction is passed from the operation instruction module 202d to the OS 201 or the content reproduction application program 203. In this way, brightness of the display in reproducing the content in the content reproduction application program 203 is increased.

As stated above, in the examples shown in FIGS. 5 to 7, instruction information corresponding to the user's finger sliding operation related to the function assigned to (each of the areas 16a to 16c included in) the touchpad 16 is passed to the OS 201 or the content reproduction application program 203. By this structure, the user can use the content reproduction function with the touchpad 16.

Further, in the examples shown in FIGS. 5 to 7, by assigning a plurality of functions (different functions) in accordance with the content reproduction application program 203 to the areas 16a to 16c included in the touchpad 16, it is possible to use several functions on the touchpad 16.

Here, it has been explained that a different function is assigned to each of the areas 16a to 16c included in the touchpad 16. However, the areas 16a to 16c may be structured such that the function is assigned to only one or two of those areas.

Further, with reference to FIGS. 5 to 7, it has been explained that fast-forward reproduction and fast-rewind reproduction of content, volume adjustment, and adjustment of display brightness are merely carried out in accordance with right and left or up and down slide operation. However, it is also possible to configure to vary the degree of fast-forward reproduction and fast-rewind reproduction, volume adjustment, and display brightness adjustment according to a distance of slide operation (finger sliding distance), for example.

The functions to be assigned to (areas 16a to 16c included in) the touchpad 16 are not limited to the above. For example, the functions of reproducing or stopping content and changing the window sizes may be assigned.

Further, while the content reproduction application program 203 has been explained, the same holds true for an application program 203 which differs in a type from the content reproduction application program 203. That is, by storing function information indicating the function in accordance with the application program 203 in the function assignment module 202b, the function in accordance with the application program 203 can be used by the touchpad 16. Specifically, in the case of an application program 203 for reading an electronic book, it is possible to assign the function of turning a page or the like to the touchpad 16 in accordance with the user's slide operation. In addition, in an application program 203 which displays a still image, it is possible to assign the function of making enlarged display or reduced display, etc., of the still image to the touchpad 16 in accordance with the user's slide operation.

If the function information indicating the function corresponding to the type of the target application program 203 is not stored in the function assignment module 202b (for example, when the target application program 203 is not a content reproduction application program), the function of operating a pointer displayed on a display monitor (hereinafter referred to as the “pointer operation function”) is assigned to the touchpad 16 (namely, the function of the touchpad 16 is not changed).

Further, the function assignment processing described above (monitoring of an active window of step S1 shown in FIG. 4) is executed for each predetermined period (certain period). By doing so, it is possible to switch the function assigned to the touchpad 16 every time (the application program corresponding to) the active window is switched. More specifically, after the content reproduction function has been assigned to the touchpad 16 as stated above, if the application program 203 corresponding to the active window is switched to an application program 203 other than a content reproduction application program, it is possible to automatically switch the function assigned to the touchpad 16 to a pointer operation function, for example (or the function in accordance with the switched application program 203).

Next, with reference to a flowchart of FIG. 8, procedure of a function cancellation processing in the present embodiment will be described. The function cancellation processing is executed by the function cancellation module 202c shown in FIG. 3. Here, in step S4 shown in FIG. 4 mentioned above, it is assumed that the target function (for example, the content reproduction function) is assigned to the touchpad 16.

In the above situation, it is assumed that a predetermined operation for cancelling the content reproduction function assigned to the touchpad 16 (hereinafter referred to as the “function cancellation operation”) has been carried out by a user on the touchpad 16. The function cancellation operation is defined in advance, and includes an operation of tapping a predetermined area of the touchpad 16, for example.

In this case, the function cancellation module 202c detects a user's function cancellation operation for the touchpad 16 (step S11).

When the function cancellation operation is detected, the function cancellation module 202c cancels the content reproduction function assigned to the touchpad 16 (step S12). If the content reproduction function is cancelled as described above, the touchpad 16 is used as a pointing device having the function of operating a pointer displayed on a display (the pointer operation function). (Namely, the function of the touchpad 16 is returned to the pointer operation function from the content reproduction function.)

Meanwhile, if the function cancellation operation is not detected, the processing of step S12 is not executed, and the content reproduction function assigned to the touchpad 16 is maintained.

Further, as described above, the function assignment processing (monitoring of an active window) is executed for each predetermined period. Therefore, even when the content reproduction function was cancelled by the function cancellation processing, for example, if the active window is not switched, the content reproduction function (the function in accordance with the content reproduction application program corresponding to the active window) is to be assigned again as the function assignment processing is executed after a lapse of predetermined time. Accordingly, even if the content reproduction function has been cancelled, it is possible to use the content reproduction function on the touchpad 16 once again.

As described above, in the present embodiment, by a structure which detects the application program 203 corresponding to the active window and assigns the function in accordance with the detected application program 203 to the touchpad 16, it becomes possible to easily use the function in accordance with the application program 203 executed on the computer 10 with the touchpad 16.

Further, in the present embodiment, by assigning a plurality of functions to respective areas in the touchpad 16, it becomes possible to use a plurality of functions by using the touchpad 16.

That is, according to the present embodiment, if the application program 203 is the content reproduction application program 203 (application program for reproducing content including video or music, etc.), for example, it becomes possible to easily perform fast-forward reproduction and fast-rewind reproduction, volume adjustment, brightness adjustment, etc., with the touchpad 16 while reproducing the content (during media reproduction).

Further, in the present embodiment, by cancelling the function assigned to the touchpad 16 in accordance with a user's predetermined operation (function cancellation operation) for the touchpad 16, even if the function in accordance with the application program 203 was assigned to the touchpad 16, it is possible to cancel the assigned function and use the pointer operation function (the function of operating a pointer displayed on a display) on the touchpad 16. Accordingly, it is possible to use a function which a user desires on the touchpad 16.

In the present embodiment, it has been described that a function according to the type of application program 203 corresponding to the active window is automatically assigned to the touchpad 16. However, the electronic apparatus may be structured such that a function according to the type of application program 203 is assigned to the touchpad 16 only when the application program 203 corresponding to the active window is the application program set in advance. In contrast, the electronic apparatus may be structured such that a function according to the type of application program 203 is not assigned to the touchpad 16 when the application program 203 corresponding to the active window is the application program set in advance. By setting the application program 203 as such by a user, it is possible to prevent the function of the touchpad 16 from being switched without the user's intent.

It is also possible to adopt a structure such that a user can customize the function assigned to the touchpad 16 for each (type of) application program 203. In this case, a plurality of functions to be assigned to the touchpad 16 are prepared for each application program 203, and a user is allowed to select a desired function from the plurality of functions.

Further, as has been explained with reference to FIGS. 5 to 7, in the present embodiment, different functions can be assigned to areas 16a to 16c, respectively. However, it is also possible to adopt a structure such that a user adjusts (sets) the range of each of the areas 16a to 16c. By adopting such a structure, the function assigned to the touchpad 16 can be serviceable for a user.

Furthermore, the electronic apparatus according to the present embodiment has mainly been described to be the notebook personal computer 10 including the touchpad 16. However, the electronic apparatus according to the present embodiment may be any type of apparatus as long as it includes a touch input module. More specifically, the electronic apparatus may be devices such as a smartphone or a tablet computer including a touchpanel display as a touch input module. In this case, a function in accordance with the application program 203 is assigned to (a predetermined area included in) a touchpanel display, and a user can use that function by operating the touchpanel display in the same way as that explained with reference to FIGS. 5 to 7, for example. By this feature, a user can similarly use the function in accordance with the application program 203 without performing a fine operation in a device such as a smartphone or a tablet.

In addition, if an electronic apparatus includes both the touchpanel display and the touchpad 16, for example, it is possible to realize a structure in which a function in accordance with the application program 203 is assigned to the touchpad 16 as described in the present embodiment, and the other functions can be used on the touchpanel display.

Since the processing of the present embodiment can be realized by a computer program, it is possible to easily realize an advantage similar to that of the present embodiment by installing a computer program on a computer by way of a computer-readable storage medium storing the computer program, and executing this computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiment described herein may be made without departing from the spirit of the invention. The accompanying claims and their equivalents are intended to cover such forms or modifications as would fall within the scope and spirit of the inventions.

What is claimed is:

1. An electronic apparatus comprising:
a touch input module;
a display;
a control module configured to make a selected window displayed on the display active;
a detection module configured to detect an application program corresponding to the active window; and
a function assignment module configured to assign a function in accordance with the application program detected by the detection module to the touch input module.

2. The electronic apparatus of claim 1, wherein:
the touch input module includes a plurality of areas; and
the function assignment module is configured to assign a plurality of functions in accordance with the application program detected by the detection module to the plurality of areas included in the touch input module, respectively.

3. The electronic apparatus of claim 1, further comprising a function cancellation module configured to cancel the function assigned to the touch input module, in accordance with a user's operation on the touch input module.

4. The electronic apparatus of claim 1, wherein the function assigned to the touch input module is usable by a user's slide operation on the touch input module.

5. The electronic apparatus of claim 1, wherein:
the application program comprises a content reproduction application program for reproducing content including video or music; and
the function assignment module is further configured to assign, at least one function from among fast-forward reproduction and fast-rewind reproduction of the content in the content reproduction application program, volume adjustment during reproduction of the content, and brightness adjustment of the display during reproduction of the content, to the touch input module.

6. A method comprising:
making a selected window displayed on a display active;
detecting an application program corresponding to the active window; and
assigning a function in accordance with the detected application program to the touch input module.

7. A non-transitory computer-readable storage medium having stored thereon a computer program which is executable by a computer, the computer program comprising instructions capable of causing the computer to execute functions of:
making a selected window displayed on a display active;
detecting an application program corresponding to the active window; and
assigning a function in accordance with the detected application program to a touch input module.
